(19) United States
(12) Patent Application Publication
(10) Pub. No.: US 2010/0128078 A1
(43) Pub. Date: May 27, 2010

(54) Method of Preventing the Formation of Inkjet Printing Artifacts

(75) Inventor: Julian Bane, Elsworth (GB)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: XAAR TECHNOLOGY LIMITED, CAMBRIDGESHIRE (GB)

(21) Appl. No.: 12/445,504

(22) PCT Filed: Oct. 17, 2007
(86) PCT No.: PCT/EP07/61119

§ 371 Date: Dec. 3, 2009

(30) Foreign Application Priority Data
Oct. 17, 2006 (GB) 0620618.9

(51) Int. Cl. B41J 2/205; H04N 1/40

(52) U.S. Cl. 347/15; 358/3.02

(57) ABSTRACT

A method for compensating for a tendency for droplets deposited by a plurality of nozzles of an ink jet printer to merge in the direction of printing on a substrate, comprising: identifying lines of pixels to be printed by each nozzle which have a grey level greater than a first threshold value; selecting certain of those pixels which are separated by a distance in the printing direction determined by a probability function and reducing the grey level of those certain pixels below a second threshold value so as to prevent merging of drops in the printing direction.

The present invention relates to droplet deposition processes, in particular to ink jet printing. More particularly, the present invention is aimed at reducing the occurrence of a particular class of visible artefacts produced by ink jet printing.

Inkjet printheads generally have one or more rows of nozzles for depositing ink onto a substrate. In a typical printing system, the printhead addresses the substrate by moving relative to the substrate in a print direction substantially orthogonal to the row direction. The nozzles deposit drops of ink, with the timing of the ink-ejections controlled so that the drops are generally laid down onto a rectilinear grid on the substrate. A particular nozzle is responsible for depositing a line of drops on the substrate extending in the print direction; the combination of the lines of drops deposited by adjacent nozzles produces an image. Thus the grid spacing in the print direction is controlled by the time delay between successive ejections by a nozzle and the spacing orthogonal of the print direction is controlled by the physical spacing of adjacent nozzles orthogonal to the print direction.

It has been found that there is a tendency for successive drops from a particular nozzle to join up to a far greater degree than for drops from adjacent nozzles to join up. Thus the ink is found to merge preferentially in the direction of print as opposed to perpendicular to the print direction. The problem is evident even when printed on an exactly square print grid. Further, droplets from adjacent nozzles merge preferentially in the direction of printing. The human eye is adept at identifying linear regions of solid tone and so such regions, which necessarily extend in the print direction, will cause particularly visible artefacts.

This joining of the drops creates “chains” and crucially, these chains cross link to adjacent chains to a far lesser degree. Depending on the exact printing process these chains can become highly visible in the finished print. UV-curable inks are found to be particularly susceptible to the formation of such chains. This may be due to the ink remaining liquid for a longer period of time, since conventional solvent or aqueous inks dry immediately they land on the substrate, whereas UV-curable inks must be cured by the application of radiation.

The causes of the general problem are complex, and from a hardware perspective, are very difficult to overcome without decreasing ejection frequency and in addition, or as a result, throughput. For example, the time delay between depositing successive drops from a particular nozzle may be increased so as to allow a greater opportunity for drops from adjacent nozzles to merge, but again this will clearly decrease throughput. Alternatively, it is possible to print the image in two passes and interleave the drops; this does prevent the chains forming to some extent but requires more than one pass over the substrate, thus decreasing overall throughput. In addition, it has been found that even some interleaving methods are vulnerable to the development of such artefacts.

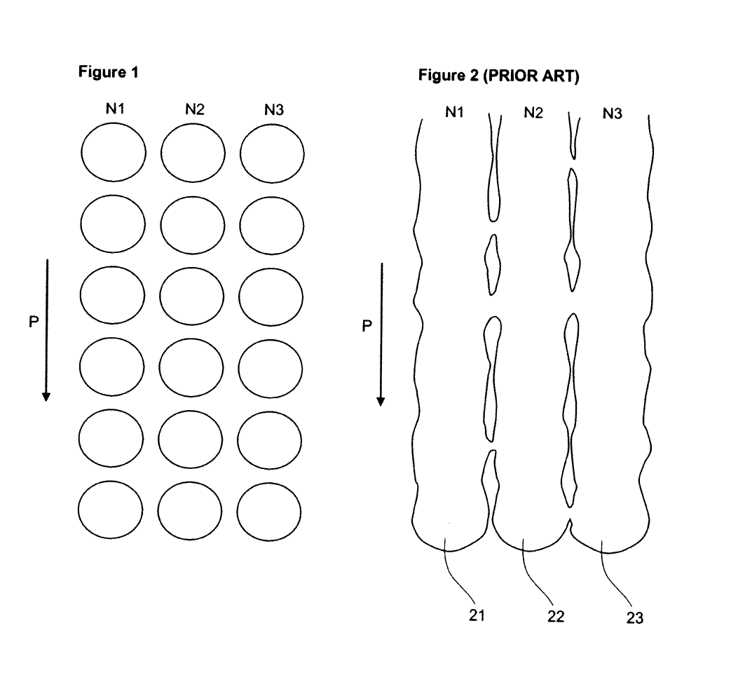

FIG. 1 shows a theoretical drop laydown pattern for three nozzles (N1, N2 and N3) of a printhead moving in a print direction P so as to form a region of continuous tone. FIG. 2 illustrates the resultant merging of droplets on the substrate, generating three such ‘chains’ (21, 22, 23) extending in the print direction P.

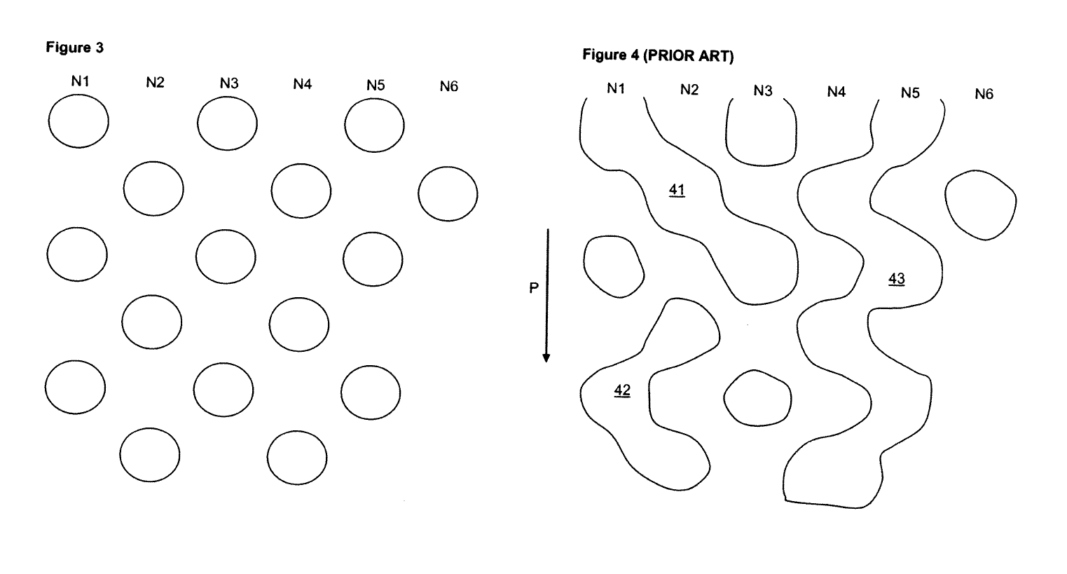

As noted above, interleaving droplets over two or more passes has also been found to generate visible artefacts in the printed image. FIG. 3 illustrates the intended droplet placement pattern for the first pass of such an interleaving operation, whilst FIG. 4 illustrates merging of the droplets that may occur on the substrate. FIG. 3 shows a ‘checker-board’ lay-down pattern produced by a row of nozzles (N1-N6) of a printhead moving in a print direction P relative to a substrate. The resulting ink pattern shown in FIG. 4 includes a variety of typical patterns displayed by merged droplets (41, 42, 43). Amongst the possible patterns shown here, serpentine patterns extending in the print direction—such as that created here by nozzles N4 and N5 (43)—are particularly visible to the human eye. Such serpentine patterns are commonly produced when an interleaving method is used to print an area of solid tone requiring large droplet sizes.

The present invention approaches the problem of ‘chain-formation’ from a control system perspective, seeking to overcome the image defects by altering the print data. Advantageously, this allows the present invention to be utilised without pervasive changes to printing hardware, granting attendant benefits through reduced implementation time and costs.

According to a first aspect of the present invention there is provided a method for compensating for a tendency for successive droplets deposited by a nozzle of an ink jet printer to merge on a substrate, comprising:

receiving first print data representing pixels to be printed by the nozzle, each of said pixels having a grey level associated with it, identifying arrays of contiguous pixels with a grey level greater than a threshold value,

reducing the grey level of selected pixels within said arrays, so as to reduce the formation of visually perceptible chains of merged droplets.

Preferably, the step of selecting pixels within said arrays comprises, for each such array, selecting pixels separated by distances determined by a probability function.

Preferably, the probability function is zero-valued for distances above a chain break distance.

Suitably, the step of reducing the grey level of said selected pixels comprises setting the grey level of each of said pixels to a chain break value, said chain break value being lower than said threshold value and being sufficient to substantially prevent the merging of adjacent droplets printed by said nozzle

According to a second aspect of the present invention there is provided a method for compensating for a tendency for droplets deposited by a plurality of nozzles of an ink jet printer to merge in the direction of printing on a substrate, comprising:

receiving print data representing pixels to be printed by the plurality of nozzles, each of said pixels having a grey level associated with it, identifying arrays of contiguous pixels with a grey level greater than a threshold value,

reducing the grey level of selected pixels within said arrays, so as to reduce the formation of visually perceptible chains of merged droplets.

The present invention will now be described with reference to the accompanying drawings, in which:

FIG. 1 shows an idealised drop laydown for three adjacent nozzles

FIG. 2 displays chains formed as a result of droplet merging following drop laydown according to FIG. 1

FIG. 3 shows an idealised ‘checker-board’ drop laydown

FIG. 4 illustrates a resulting droplet merging pattern following drop laydown according to FIG. 3

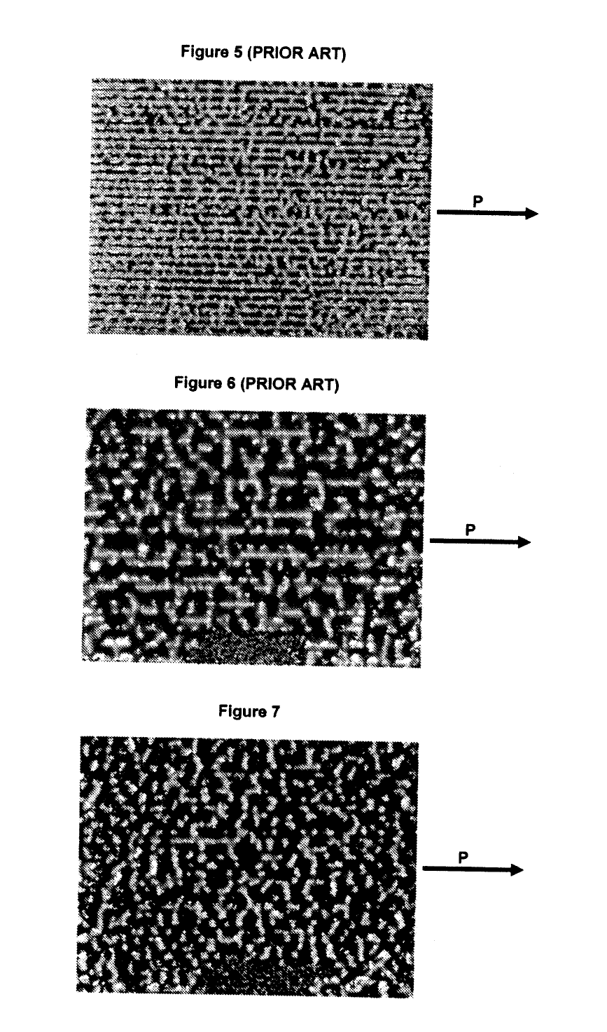

FIG. 5 shows a printed image using UV ink formed according to a prior art method

FIG. 6 shows a magnified image similar to FIG. 5, displaying the artefacts in detail

FIG. 7 shows a printed image resulting from the application of the present invention to the same print data as FIG. 6

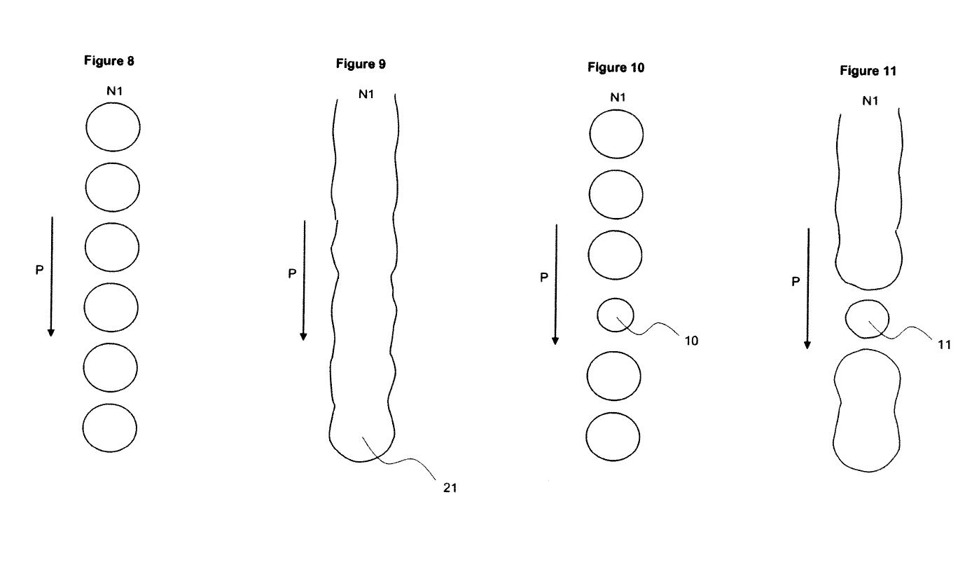

FIG. 8 shows an idealised drop lay-down for a single nozzle printing continuos tone

FIG. 9 shows a chain formed by the merging of drops following drop laydown according to FIG. 8

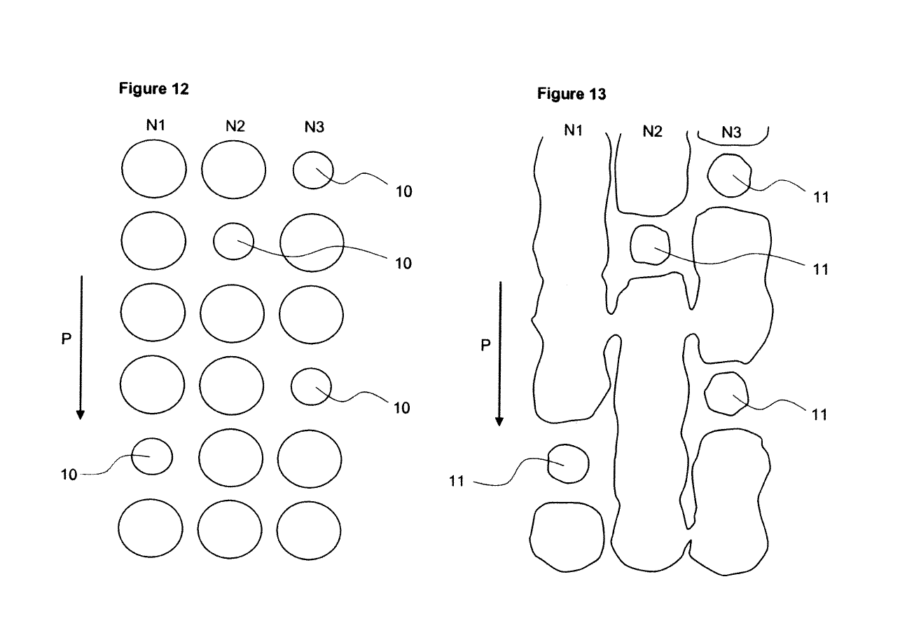

FIG. 10 shows an idealised lay-down resulting from the application of the present invention to the same print data as FIG. 8

FIG. 11 illustrates the chain of FIG. 9 broken following the application of the present invention

FIG. 12 shows a further idealised drop lay-down for three adjacent nozzles following the application of the present invention to similar print data to FIG. 1

FIG. 13 shows an exemplary drop merging pattern resulting from the lay-down of FIG. 12

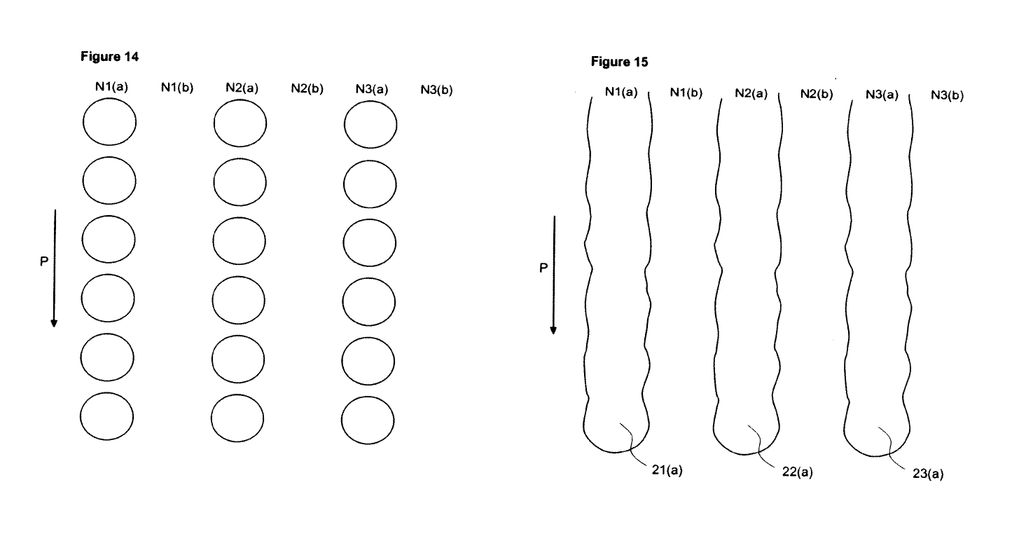

FIG. 14 illustrates an idealised drop lay-down for the first row of nozzles of a two row printhead

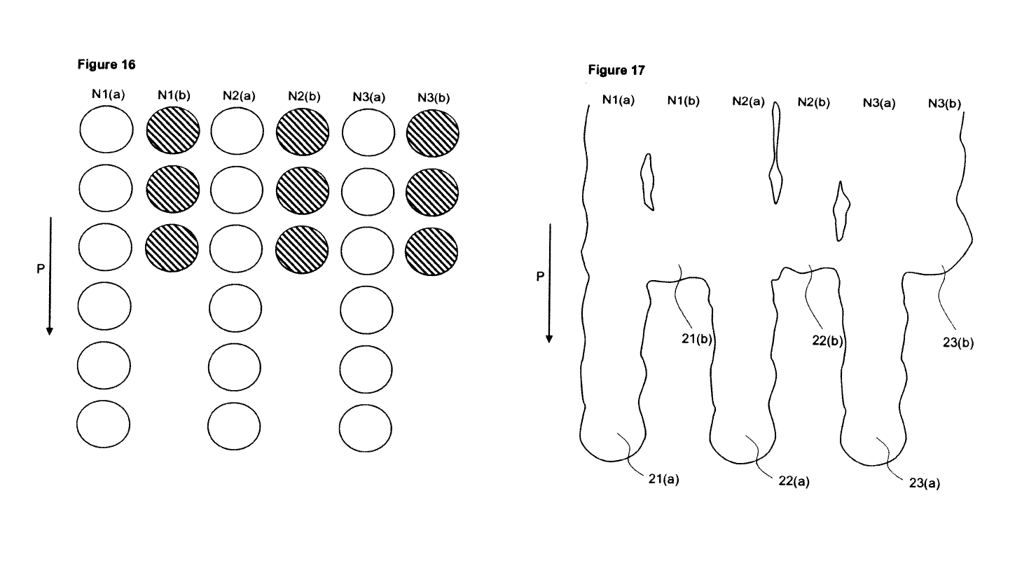

FIG. 15 displays ‘chains’ resulting from the drop lay-down of FIG. 14

FIG. 16 shows an idealised drop laydown for the ‘in-fill’ droplets from the second row of nozzles following drop laydown according to FIG. 14

FIG. 17 illustrates a exemplary merging pattern of ink droplets on a substrate following deposition according to FIG. 16

The present invention solves the problem of chain formation by reducing the size of certain selected droplets within the print pattern, thus inhibiting merging on the substrate. FIG. 5 shows a magnified printed image formed using UV-curable ink where the artefacts in question are particularly visible. The print direction P is from left to right; chains formed in the image are apparent at this magnification and would be perceptible at a normal viewing distance. FIG. 6 shows a similar printed image under greater magnification showing the horizontally extending chains in more detail. FIG. 7 shows a printed image of the same print data as FIG. 6, with the data printed according to present invention. The effect of the application of the present invention is clearly visible, with merging of droplets now substantially isotropic, thus removing chain artefacts.

FIGS. 8 and 9 show respectively a theoretical drop lay-down for a single nozzle (N1) printing continuous tone, and what might actually result when printing in direction P from top to bottom. By contrast, FIG. 10 illustrates a theoretical drop lay-down for a single nozzle printing the same data as in FIG. 8 in accordance with the present invention. The size of the fourth drop that is deposited (10) is reduced in comparison to the original print data, so as to inhibit merger in direction P. FIG. 5 illustrates the effect of the present invention on the ‘chain’ (21) that is shown in FIG. 9: the ‘chain’ has been broken by reducing the size of the fourth droplet to be printed so that it forms a separate ink dot (11). This is an example of the effect of the present invention when used in conjunction with a greyscale printhead, thus allowing control over the size of each drop.

FIGS. 12 and 13 show respectively a further theoretical drop lay-down for three adjacent nozzles (N1, N2 and N3) printing continuous tone print data in accordance with the present invention, and the resultant patterns of merged droplets on the substrate after printing. The lay-down of FIG. 12 includes several drops of reduced size (10) in comparison with the lay-down of FIG. 1, where all drops are of identical size. As is shown in FIG. 13, this tends to separate the ink dots corresponding to these reduced size drops (11) from chains that might otherwise form (21, 22, 23) as shown in FIG. 2. As is illustrated by FIGS. 12 and 13, the application of the present invention has little effect on cross-linking between ‘chains’.

An embodiment of the present invention prevents chains forming through inserting gaps in the line generated from a single nozzle. The present invention may be embodied as an algorithm applied to print data and is adaptable for use with both binary and greyscale printheads.

The chain breaking method in accordance with the present invention may take account of two critical drop sizes that may be determined either theoretically or empirically by experimentation. With graphics applications, such experimentation may comprise studying the printed image by eye for visible defects, whereas when the invention is applied to functional fluids the point-to-point conductivity and functionality of the printed structure may be tested. These drop sizes will correspond to two grey levels in the print data, and it is these grey levels that are determined in practice. Only one such determination is required for each combination of ejection fluid, substrate and printhead apparatus.

The first parameter is the maximum size of drop that can be printed without forming a chain. This is referred to hereafter as “ChainBreakLimit”. The second is the maximum drop size that can be printed that will break a chain that is forming. This is referred to hereafter as “ChainBreakDrop”. In a binary image these drops may both be a zero-sized drop (i.e. a space) but with a greyscale printhead these would most likely be non-zero sized drops.

A further parameter that may be determined is the maximum number of drops to be allowed in a chain. This may be determined empirically by experimentation, balancing the need to remove chain artefacts with the reduction in optical density of the image that would result from breaking too many chains. This parameter is referred to hereafter as “ChainBreakLength”.

In a first example embodiment the chain breaking method considers the sizes of droplets previously printed by a nozzle. Before printing the next drop the pixel's grey level is compared the with the ChainBreakLimit parameter. If it is smaller the droplet is printed; if larger, the number of previous successive drops greater than ChainBreakLimit that had been printed by that nozzle is summed—this is the theoretical current chain length (referred to below as ChainSum). The ratio of the current chain length to the ChainBreakLength is computed and compared to a random (or pseudorandom) number; if the ratio is greater than the random number then the size of the droplet is set to the ChainBreakDrop size.

This embodiment may be represented by the following code:

if DropSize > ChainBreakLimit then

ChainSum = 0
iCount = 1

while DropSize(XPosition-iCount) > ChainBreakLimit

ChainSum = ChainSum + 1
iCount = iCount + 1

wend
if ChainSum/ChainBreakLength > rnd then

DropSize = ChainBreakDrop

end if

end if

The function “rnd” here may be substituted for any random function. The sole constraint is that the probability of replacing the current drop which is larger than ChainBreakLimit with one of ChainBreakDrop drop size increases with chain length that has already been printed.

According to a further embodiment of the present invention the pixel's grey-level may be compared to not only a lower limit, but also an upper limit so that if it is between this lower limit (referred to hereafter as “ChainBreakLowerLimit”) and this upper limit (referred to hereafter as “ChainBreakUpperLimit”) the number of previous drops within this range is summed to provide a ChainSum value. This value may then be utilised as before in the determination of whether or not to print the drop in question. Drops outside of this range will always be printed, which may be found to particularly benefit applications where large areas of maximum coverage are required.

In a still further embodiment, chain-breaking drops will be spaced by a pre-determined constant distance. Thus, no comparison is made with a random variable and pixels within a chain separated by this constant distance are set to the ChainBreakDrop value. This distance may optionally be set to the ChainBreakLimit value.

It has been found that the cross-merging of drops between chains is essentially independent to the application of this embodiment of the present invention: the resultant linking in the two directions is thus more balanced.

In a further, more general embodiment of the present invention, areas of contiguous pixels with grey levels greater than the ChainBreakLimit value are identified. Pixels within these areas are then set to the ChainBreakDrop value. These pixels may preferably be spaced according to a probability distribution as in the previous embodiment, by a standard dither pattern, or may optionally be spaced by a constant distance.

This embodiment of the invention has been found to be particularly effective at reducing the appearance of artefacts produced by printheads using a ‘checker-board’ lay-down pattern on a substrate as is shown in FIG. 3. Conventional ‘checker-board’ methods have been found to reduce to some extent the merging of droplets to form chains but, as mentioned above, there is a tendency for serpentine artefacts (as illustrated in FIG. 4) to extend preferentially in the print direction (such as 43, FIG. 4).

FIG. 14 shows idealised droplet placement for the nozzles of the first row (N1(a)-N3(a)) of a two-row printhead; the nozzles of the two rows are interspersed. As before, such a placement pattern is likely to lead to the formation of “chains” (21(a)-23(a)) extending in the print direction P as illustrated in FIG. 15. The ‘in-fill’ droplets (shown shaded in FIG. 16) as deposited by the second row of nozzles (N1(b)-N3(b)) will arrive at the substrate after a lag-period of time. The idealised droplet placement pattern for this is shown in FIG. 16. This lag-period will affect the cross-linking between chains formed by the first nozzle row (21(a)-23(a)) and chains formed by the second nozzle row (21(b)-23(b)) as shown in FIG. 17. Oftentimes, this extra lag time will tend to increase the formation of “chains” in comparison to the equivalent single-row system as more time will be available for the merger of a drop with drops from the same nozzle than with drops from the belonging to the second row. The method according to the present invention may be adapted suitably; this may comprise using a different chain break method for each nozzle row. Additionally, the droplets deposited by the end nozzles will behave differently and a suitably adapted chain breaking method may be utilised.

According to another technique known in the art, a printhead is disposed at a non-perpendicular angle to the direction of print in order to decrease the effective distance between droplets ejected by adjacent nozzles. With such techniques there is a lag period between the time when a first nozzle deposits a droplet and an adjacent nozzle deposits a droplet—this ensures that droplets are deposited in a regular grid rather than the angle of the nozzle row. The present invention may also be suitably adapted to take account of this time delay.

It is quite clear that the above methods will reduce the overall density of the image. The exact reduction of the image density is dependant on the parameters described above and the random function used to generate the chain break positions. As a conservative estimate we can assume it has a maximum percentage of 100*(2/ChainBreakLength).

The reduction in size of a droplet can be considered as an error in the print data. Oftentimes this error will be visually imperceptible in the printed image and no further processing may be necessary. Various algorithms for the distribution of errors in pixel colour depth are known in the art of computer graphics and these may be advantageously adapted for use with the present invention. For example, dithering algorithms such as the Floyd Steinberg algorithm may be used to transfer the error in droplet size to adjacent pixels.

In particular, care must be taken to modify the error diffusion algorithm to take account of the following constraints. Firstly, it is sensible to reduce or zero the proportion of the error transferred in the direction of print as this will tend to increase the size of the following drop, thus encouraging the creation of a further chain in the print direction. Preferably, the errors are transferred to pixels to be printed by a different nozzle. More preferably, two chain breaks should not be placed adjacent to each other perpendicular to the direction of print as the intention is to increase the cross-linking in this direction. The error diffusion algorithm need not be applied to only the adjacent pixels, but preferably operates over an area that will be perceived in the printed image to be of constant optical density.

The aforementioned methods may be applied as a pre-processing stage, or as part of a raster image processing (RIP) operation, thus altering the print image data as a whole, and also concurrently with the printing operation, on a pixel-by-pixel basis.

It will be apparent to those skilled in the art of printing methods that the present invention may be adapted for use with either greyscale or binary printheads. Further, the present invention may be embodied in a software program operable to process print data, or as an ASIC connectable to, or integral with a printhead. Of course, while the invention may have particular benefit in graphics applications where a printed image is formed of pigment or ink using an inkjet printer, the advantages of the present invention will be afforded with all types of droplet deposition apparatus, substrate and ejection fluids, including the use of functional fluids capable of forming electronic components. Thus, it will be understood that where reference is made to a ‘grey-level’ within this document that this is a term-of-art for the size of the fluid droplet deposited and should not be seen to limit the fluid to a particular colour, or composition. Further, the foregoing teachings may be easily applied to binary systems by considering such systems as having only two grey-levels corresponding to ejection or non-ejection of a drop.

1. Method for compensating for a tendency for droplets deposited by a plurality of nozzles of an ink jet printer to merge in the direction of printing on a substrate, comprising:
receiving print data representing pixels to be printed by the plurality of nozzles, each of said pixels having a grey-level associated with it,
identifying arrays of contiguous pixels with a grey level greater than a threshold value,
reducing the grey level of selected pixels within said arrays, so as to reduce the formation of visually perceptible chains of merged droplets by forming one or more chain breaks.

2. Method according to claim 1, wherein said arrays are lines of pixels to be printed by each nozzle having a grey-level greater than a threshold value.

3. Method according to claim 1, wherein the step of selecting pixels within said arrays comprises, for each such array:
selecting pixels separated by distances in the direction of printing determined by a probability function.

4. Method according to claim 3, wherein the probability function is zero-valued for distances above a chain break distance.

5. Method according to claim 1 wherein the step of reducing the grey level of said selected pixels comprises:
setting the grey level of each of said selected pixels to a chain break value, said chain break value being lower than said threshold value and being sufficient to substantially prevent the merging of adjacent droplets printed by the same nozzle.

6. Method according to claim 1 wherein said selected pixels printed by each nozzle are staggered in the direction of printing with respect to selected pixels printed by nozzles adjacent orthogonal to the print direction.

7. Method according to claim 1 further comprising redistributing the error caused in reducing the grey level of said selected pixels over nearby pixels.

8. Method according to claim 7 comprising redistributing said error over pixels within lines adjacent in the printed image.

9. Method according to claim 7 comprising redistributing said error over adjacent pixels.

10. Method according to claim 7 comprising redistributing said error using a dithering algorithm.

11. Method according to claim 1 wherein two grey levels are provided, corresponding to ejection or non-ejection of a droplet.

12. Droplet deposition apparatus configured to perform a method according to claim 1.

13. Computer program product configured to perform a method according to claim 1.

14. Logic circuitry configured to perform a method according to claim 1.

15.-19. (canceled)

20. Droplet deposition apparatus configured to perform a method according to claim 5.

21. Computer program product configured to perform a method according to claim 5.

22. Logic circuitry configured to perform a method according to claim 5.

23. Droplet deposition apparatus configured to perform a method according to claim 7.

24. Computer program product configured to perform a method according to claim 7.

25. Logic circuitry configured to perform a method according to claim 7.
